(19) United States
(12) Patent Application Publication
(10) Pub. No.: US 2015/0135849 A1
(43) Pub. Date: May 21, 2015

(54) System for Production Boosting and Measuring Flow Rate in a Pipeline

(71) Applicant: Caltec Limited, Bedfordshire (GB)

(72) Inventors: Mirza Najam Ali Beg, Milton Keynes (GB); Mir Mahmood Sarshar, Buckinghamshire (GB)

(21) Appl. No.: 14/541,011

(22) Filed: Nov. 13, 2014

(30) Foreign Application Priority Data
Nov. 15, 2013 (GB) 1320202.3

(51) Int. Cl. G01F 1/66; E21B 47/00

(52) U.S. Cl. CPC G01F 1/667; E21B 47/00
USPC 73/861.18

(57) ABSTRACT

A system for measuring flow rate in a pipeline by use of a surface jet pump that receives input from both a high pressure pipeline and a low pressure pipeline. Rather than installing flow meters at any or all of the inputs/output from the SJP which is an expensive undertaking, flow rate is predicted by utilising existing pressure sensors located on the high pressure pipeline, low pressure pipeline and discharge pipeline respectively. A control processor predicts flow rate based on correlations between flow rate and pressure for a given SJP geometry and, for example, utilises momentum, conservation of mass and continuity equations, balanced against the pressure forces and velocity in the SJP.

### CROSS-REFERENCE TO RELATED APPLICATIONS

This application claims foreign priority benefits under 35 U.S.C. §119(a)-(d) to United Kingdom patent application number GB 1320202.3 filed Nov. 15, 2013, the disclosure of which is hereby incorporated in its entirety by reference in its entirety.

### TECHNICAL FIELD

The present invention relates to a system for measuring flow rate in a pipeline and, specifically, configuring a surface jet pump (hereinafter “SJP”) as a means of measuring flow rate, in addition to its normal duty of pressure/production boosting.

### BACKGROUND TO THE INVENTION

The measurement of fluid flow rates produced from a well is an important part of production management and assessment of reservoir behaviour. In many cases, such as offshore oil and gas production, a test separator is installed and production from each well can be diverted to the test separator for measurement of oil, water and gas. In most of such cases the wells can only be tested at the pressure dictated by the production manifold, as separated gas and liquid phases from the test separator are diverted back to the production header.

It is known to install a multiphase meter instead of the test separator; however, there are a number of issues such as cost and lack of measurement reliability which discourage the use of multiphase meters by many operators.

In the case of onshore oil or gas production, the wells are scattered over a large area and diverting each flow into a test separator is only practical where production from the wells reaches a gathering station, i.e. a test separator can be installed at that location. In any event, in these cases the wells can only be tested at the pressures equal to or above the production pressure of the manifold.

Testing wells at pressures below that of the manifold pressure is often essential as a means to evaluate the use of production boosting systems, installed downhole or at surface, to increase production. However, testing wells at pressures below the manifold pressure requires additional facilities to boost the pressure of produced gas and liquids so that the fluids can then be diverted back to the production header or manifold. Such facilities are known in the prior art, e.g. a compact separation and boosting system which enables wells to be tested at pressures below that of the production header.

Selection of the best system to measure production rates of fluids is very much related to site conditions, economics and the operator's attitude to production management. The present invention seeks to utilise available devices to assist in measuring fluid flow rates during production.

Surface Jet Pumps (SJPs), as illustrated by FIG. 1, are passive devices and do not need any active control or measurements. However, it is recommended to include at least three pressure transmitters or gauges and also temperature sensors (as optional) to monitor how the unit is performing.

By contrast, in order to measure flow at the SJP, there are often no flow meters available. Many times, due to the location of the SJP, an operator does not have any flow rate data to estimate production gain, e.g. more flow from low pressure stream or increase in total discharge flow, by the SJP. It is desirable to know the current flow rate passing through the SJP for reasons as outlined above.

### BRIEF DESCRIPTION OF THE DRAWINGS

FIG. 1 illustrates a prior Surface Jet Pump (SJP);

FIG. 2 illustrates an embodiment of the invention where sensors on the SJP are used to determine flow rate;

FIG. 3 illustrates an alternative embodiment of the invention;

FIG. 4 illustrates a further alternative configuration; and

FIGS. 5 and 6 illustrate performance curves generated according to the invention.

### DETAILED DESCRIPTION OF THE INVENTION

According to an aspect of the invention it is proposed to use existing pressure sensors (PTs) on the SJP to approximate flow rates based on correlations and cross-referencing the pressure values.

In practice, flow rate information will be a displayed or stored output, calculated by suitable software that has a database of established relationships between flowrates and pressures at inlets and outlets, based on the geometry of the SJP compiled through experience and experimentation. The software can be prepared and flow rate determined using momentum, conservation of mass and continuity equations, balanced against the pressure forces and velocities in the SJP.

Accordingly, data collected can profile unique behaviour allowing the software to deduce missing information/unknown flowrates. The system can be verified and optimised by use of an actual flow meter but, in the field, the SJP monitored by existing sensors becomes a flow meter.

Once enlightened to the inventive concept, correlations can be developed for more complex multiphase flow situations. In such cases, i.e. multiphase flow, there can be multiple solutions and, therefore, to minimise this issue it is suggested to include other devices, such as separator or other meters.

The present invention is applicable to gas wells which produce below 1% to 2% liquids by volume at conventional operating pressures and temperatures and use surface jet pumps to boost their production. The suggested limit for the liquid flow rate is due to the fact that within this range of liquids the performance of the SJP and values such as low pressure (hereinafter ‘LP’) generated by the SJP will not change significantly.

In the same way, this approach is also applicable to an oil well with free gas limit in low pressure stream of up to 5% by volume. The stated limit for the gas flow rate is due to the fact that within this range of gas the performance of the SJP and values such as low pressure (hereinafter ‘LP’) generated by the SJP will not change significantly

As will be mentioned hereinafter, with the use of separation on the high pressure (HP) or LP stream, the range of operation of this invention can be extended from 0% to 100% of gas in the liquid or vice versa.

In order to predict the flow rate of gas produced from the well, all is needed is the operating pressure of the SJP on the HP and LP inlet side of the SJP and its discharge pressure. As mentioned, software has been developed which enables to calculation and prediction for the flow rate of gas from the well which the SJP receives by monitoring the said operating pressures (HP, LP and discharge pressures of the SJP). This technique eliminates the need to have dedicated flow meters for each well and enables measurement of the flow rate of gas within the same level of accuracy which flow meters offer (i.e. 5% to 10% accuracy). In cases where more than 1% to 2% liquid is produced with gas volumetrically at the operating pressure and temperature, two unknowns (gas flow rate and liquid flow rate) are involved. However, if the flow rate of the gas phase is known, the software can still analyse and predict the flow rate of liquids at the operating conditions.

As a further aspect of the invention, there are multi beam ultrasonic gas flow meters which, even in the presence of liquids, can measure the velocity of the gas phase within +/−5% accuracy, but so far these meters cannot predict the liquid flow rate. Accordingly, a combination of a multi beam ultrasonic meter or an equivalent meter, with a SJP also enables the flow rate of the liquid phase to be computed. This is achieved by feeding the information on the gas flow rate (obtained from the gas meter) to software used for predicting the performance of the SJP. In this case the software has one unknown to solve (the liquid flow rate). Therefore, via the combination of a SJP and a multi beam gas meter the flow rate of produced gas and liquids can be calculated.

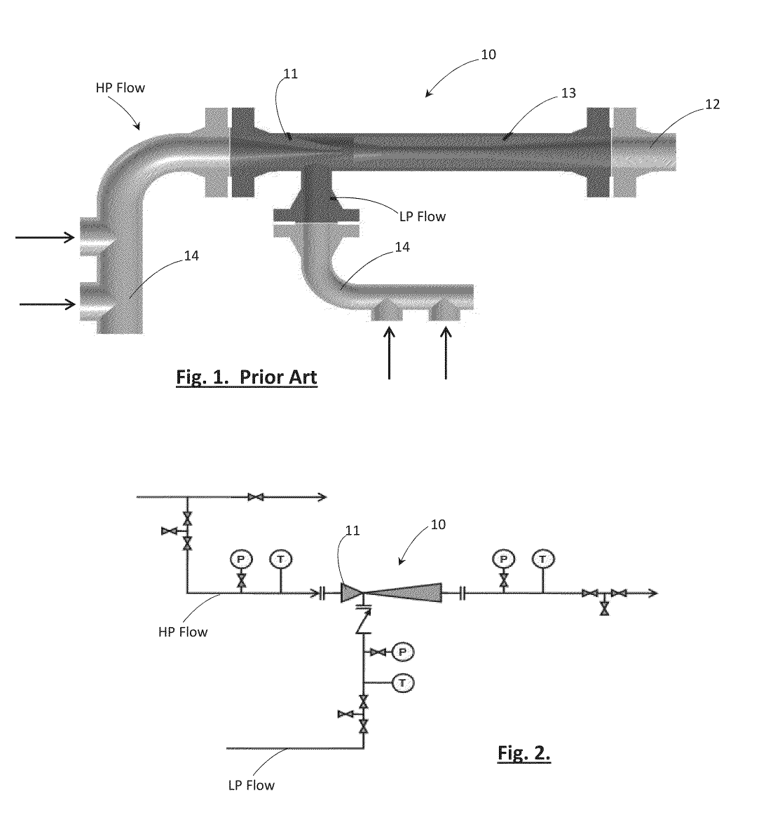

By way of background, a standard SJP device is illustrated by reference to FIG. 1. Here, inlet manifolds 14 direct a high pressure (HP) and low pressure (LP) flow respectively into the SJP 10. The HP flow passes through a high pressure nozzle 11 and incoming LP flow is subsequently mixed within the diffuser section 13. Mixed flow is discharged as a comingled product from outlet 12.

It was recognised by the inventors that a SJP installed to reduce the back pressure on selected wells can provide valuable information on the productivity and characteristics of the wells at a given flowing wellhead pressure. In order to measure or predict the production rate of gas from a gas well in absence of a test separator or flow meter, the surface jet pump can provide such valuable information by monitoring/recording the LP pressure which it has generated. The LP inlet pressure of the SJP is always measured easily, using pressure gauges or pressure transmitters which are always part of the system for monitoring the performance of the SJP.

FIG. 2 shows an arrangement of a SJP 10 in a pipeline system with pressure P and temperature T sensors at each inlet/outlet. Control software monitoring the various sensors can approximate/predict flow rates in the system according to the invention.

The HP nozzle 11 alone can infer the HP flow rate passing through it by knowing the temperature and pressure value on the HP stream (along with correlation data accessible by the control software and its specific internal dimension). The pressure difference (and correlations) between the inlet LP stream and the discharge stream can indicate the LP flow rates across the SJP body (by knowing its specific critical internal dimension). A combination of these two aspects can be used for flow rate estimation.

In order to estimate flowrate in a complex mixture of gas-liquid (multiphase flow) flow, it is possible to use flow detection sensors or other commercially available devices such as densitometers, GVF (Gas Volume Fraction) meters, that are further added to the proposed system.

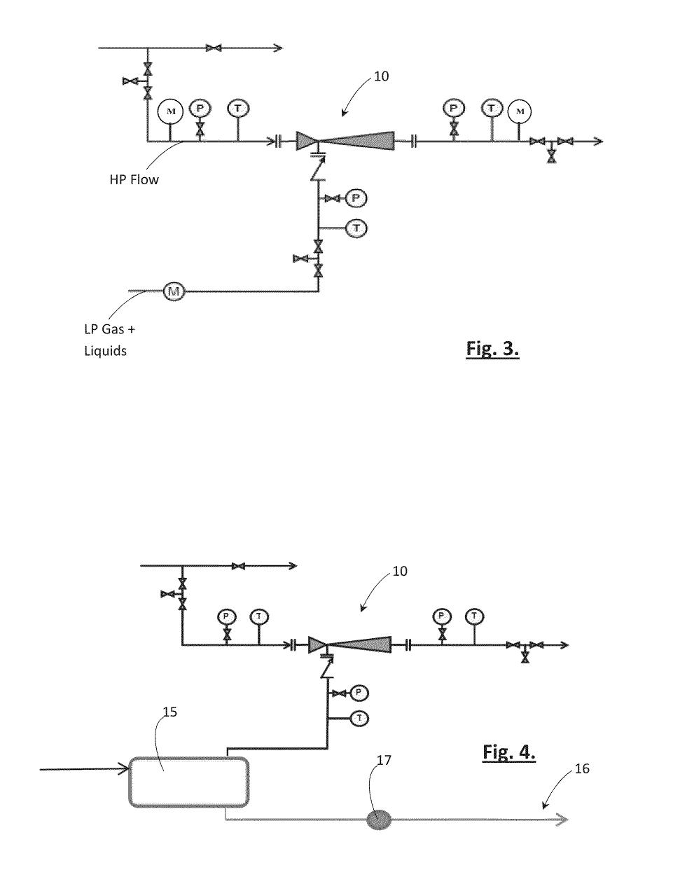

An alternative option is to include a limited number of flow meters (M) adjacent to the SJP to reduce cost compared to a full complement of flow meters. Particularly, using any two out of three flow meters (M) as shown in FIG. 3 will provide sufficient indication of the flow in the third pipeline and total flow rates via the SJP. The location of the flow meters can be chosen based on the piping of the particular situation. The invention suggests supply as part of integrated system (boosting and metering) with SJP, pressure sensors and meters as one system.

In practice flow meters will most likely be associated with the HP line and LP line respectively. It is an aspect of the invention that a boosting SJP is supplied with meters integrally installed, but with the minimum number of components that can still provide data for flow rate in all parts.

Referring to FIG. 3, a combination of a multibeam ultrasonic meter M or an equivalent meter, with a SJP also enables the flow rate of the liquid phase to be computed. This is achieved by feeding the information on the gas flow rate (obtained from the gas meter M) to software used for predicting the performance of the SJP. In this case the software has one unknown to solve (the liquid flow rate). Therefore, via the combination of the SJP and the multisource gas meter the flow rate of produced gas and liquids can be calculated.

As a variation to the above described systems, there could be cases where there is a separator 15 upstream of the SJP which separates the LP gas and liquid phases as shown in FIG. 4. In this case the liquid flow 16 can be measured by a standard liquid flow meter 17 such as an orifice plate or v-cone type, and the SJP 10 which receives the gas phase only provides the information on gas flow rate by the method explained by reference to FIG. 2.

Flow rate prediction is intended to be implemented by suitable software. The software developed and validated for the design and prediction of surface jet pump performance enables the mass and momentum balance of the fluids passing at different points through the SJP to be calculated. This is achieved by splitting the internal parts of the SJP into several sections; where for each section mass and momentum balance equations are generated, taking into account the fluid properties of gas and liquids passing through the SJP.

The equations generated are then solved using a powerful mathematical model. The software therefore enables one of the unknowns such as the generated LP pressure or LP gas flow rate to be predicted.

In cases where some liquid is produced with LP gas, if the LP pressure at the inlet to the surface SJP is measured and is therefore known, and the LP gas flow rate is known or measured by other means such as a multi beam ultrasonic flow meter, then the remaining unknown will be the flow rate of the liquids, which the software is able to predict as the example in Table 1 below shows.

TABLE 1

| | High Pressure | | Low Pressure | | Discharge Pressure | |
|---|---|---|---|---|---|---|
| Case | Pressure | Flow rate | Pressure | Flow rate | Predicted | Boost |
| 1 | 100 barg | 40 | 10 barg | 10 | 25 barg | 15 bar |
| | | MMscfd | | MMscfd + | | |
| | | | | 0 bbl/d | | |
| | | | | (GVF = | | |
| | | | | 100%) | | |
| 2 | 100 barg | 40 | 14 barg | 10 | 25 barg | 11 bar |
| | | MMscfd | | MMscfd + | | |
| | | | | 2020 bbl/d | | |
| | | | | (GVF = | | |
| | | | | 98.5%) | | |

Case 1 shows the performance of the SJP with only LP gas passing through the SJP under a given motive (HP) pressure . The underlined values where calculated by the software. Case 2 shows the estimation of LP liquid flow rate when LP pressure and LP flowrates are entered along with other pressures. In these examples the software has predicted the LP liquid flow rate at the given LP gas flow rate and the measured LP pressure for each case with different LP flow rate.

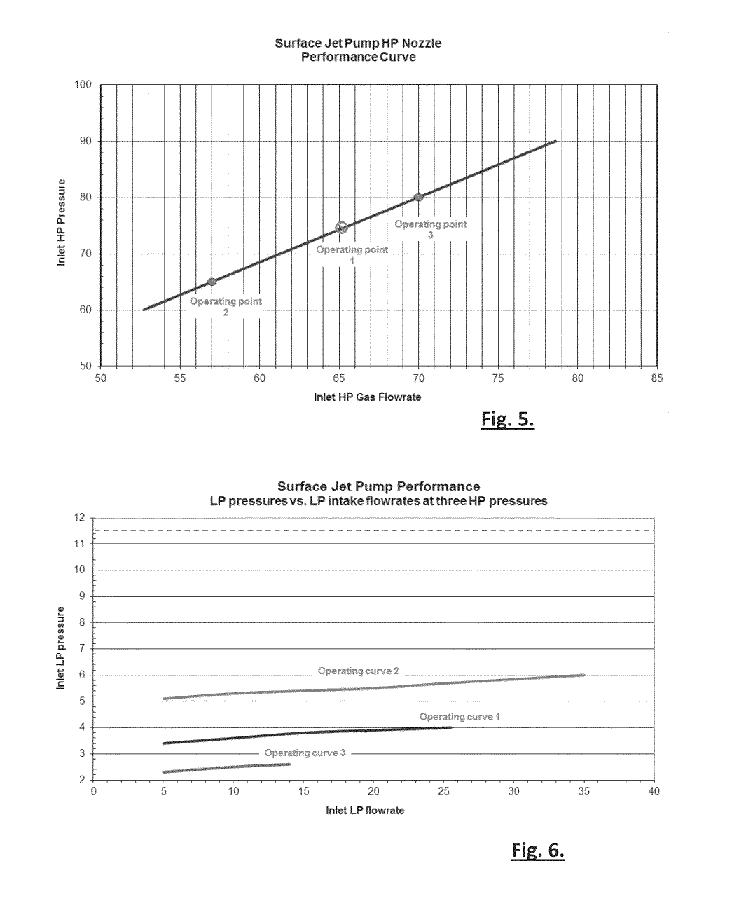

FIGS. 5 and 6 provide example performance curves generated by software according to the invention (Table 1 was also generated by this software). In the example an SJP operates in the field with fairly clean fluids, for that particular geometry of the SJP, FIGS. 5 and 6 are the performance curves generated.

Referring to FIG. 5, a linear relationship is observed between pressure and flow rate for a given geometry, e.g. y=0.8643x+0.8252; R²=1. According to the graph, for the HP nozzle of the SJP, it is possible to read off the HP pressure on the SJP. The HP flow rate (gas or liquid service) can be calculated. In the example, the SJP pressure gauge is reading HP pressure being 80 (at operating point 3), from the HP nozzle curve, flow rate of 70 is predicted. Using software, values can also be entered for operating temperature, gas composition etc. to estimate gas flow rate for that particular geometry according to established relationships.

FIG. 6 shows SJP overall performance curves. From the HP nozzle, we have established HP flow rate going into the SJP and the curve to use in this graph, which is operating point 3. Now LP pressure at the inlet of SJP can be determined. For example, it is reading 2.5 on the pressure, and based on that we read an LP flow rate to be 10. With software, the same can be calculated without example curves by accounting for temperature and composition etc..

Hence the total flow passing through the SJP is HP+LP=80 at the discharge pressure read at the outlet of the SJP.

In software, the geometry of the device can be changed, and the flowrates re-calculated if needed (in other words, reproduce these curve). Hence, this SJP is not only a production booster, but it can be a meter too, according to the invention.

The curves in FIG. 6 show jet pump response trend situations, akin to a calibration curve of a metering device. When pressure readings are available according to the invention, a judgement on the flow rates (because there is no dedicated meter) in the field can be made. If additional information is available on the fluid properties and or gas/liquid phases, then specialised software is used (generating curves and also a table such as Table 1). The particular units are specific to application. For the shown curves, the flow rates are in MMscfd and pressures are in barg, however other units may be applicable for both of these properties. The slope and length of curves will change moderately depending on the actual application and physical design geometry of the surface jet pump.

The operating points (OP) on the curves is shown to link conditions in FIG. 5 to FIG. 6. The OP shows the suggested operating limit of device based on the available parameters defined by the operator. For example, OP1, is a normal operational situation, and sets the baselines for designing the system. OP3 is the maximum deviation in highest flow rates defined by the operator, and this curve shows that how it is handled by system (giving flow and pressure relationships—becomes a meter). The same goes for OP2, which is the minimum flow conditions (that can be) defined by the operator. In other words, this is the operating envelop of a fixed design device, to operate outside this regions, physical modifications to the device are needed.

Table 1 shows (as output of software) a more complex situation where liquid phase is involved and either gas or liquid is measured by some other means. Such a state is not easy to show in graphical form due to another dimensions involved of this complex system. Hence Table 1 shows that, by adding input parameters (which are not underlined) into the software, some other unknown can be estimated (in order for the SJP to become a meter) by balancing the internal equations.

For case, 1, just like the curves, flow rate is estimated; whereas for case 2, unlike FIG. 6 curves, the LP liquid flow rate is estimated.

It will be clear that the curves in FIG. 6 and Table 1 are not from the same operating case.

1. A system for measuring flow rate in a pipeline, including:
a high pressure pipeline;
a low pressure pipeline; and
a surface jet pump receiving input from both the high pressure pipeline and low pressure pipeline;
a discharge pipeline of comingled products output from the surface jet pump;
at least three pressure sensors located on the high pressure pipeline, low pressure pipeline and discharge pipeline respectively;
a control processor monitoring information input from the pressure sensors; wherein the control processor predicts a flow rate in at least one of the high pressure pipeline, low pressure pipeline and/or discharge pipeline based on correlations between flow rate and pressure for a given surface jet pump geometry.

2. The system of claim 1 wherein the control processor utilises momentum, conservation of mass and continuity equations, balanced against the pressure forces and velocities in the surface jet pump.

3. The system of claim 1 wherein the control processor has access to or maintains a database of established relationships between flowrates and pressures at inlets and outlets across the surface jet pump, based on the geometry of the surface jet pump.

4. The system of claim 1, further including at least one temperature sensor located on the high pressure pipeline, low pressure pipeline and discharge pipeline respectively, readings from which are utilised by the control processor to assist flow rate calculations.

5. The system of claim 1, further including a separator in the low pressure pipeline for separating gas and liquid phases, wherein the gas phase is used as an input for the surface jet pump, the flow rate of which is predictable by the control processor.

6. The system of claim 5 wherein a liquid phase output from the separator has a liquid flow meter.

7. The system of claim 6 wherein the liquid flow meter is an orifice plate, ultrasonic or v-cone type.

8. The system of claim 1 further including a flow meter in the low pressure pipeline for measuring flow rate of gas only, wherein flow rate of the liquid is predicted by the control processor monitoring the surface jet pump.

9. The system of claim 8 wherein the flow meter is a multi beam ultrasonic meter.

10. The system of claim 1 further including a flow meter in the low pressure pipeline for measuring flow rate of liquid only, wherein flow rate of the gas is predicted by the control processor monitoring the surface jet pump.
